(19) United States
(12) Patent Application Publication
(10) Pub. No.: US 2012/0096709 A1
(43) Pub. Date: Apr. 26, 2012

(54) APPARATUS FOR MANUFACTURIING TRANSPARENT ELECTRODE USING PRINT-BASED METAL WIRE

(75) Inventors: Jeong-Dai Jo, Daejeon (KR); Jong-Su Yu, Daejeon (KR); Jung Su Kim, Busan (KR); Seong-Man Yoon, Yeongi-gun (KR); Sung Woo Bae, Daejeon (KR); Dong-Soo Kim, Daejeon (KR)

(73) Assignee: KOREA INSTITUTE OF MACHINERY & MATERIALS, Daejeon-city (KR)

(21) Appl. No.: 13/223,365

(22) Filed: Sep. 1, 2011

(30) Foreign Application Priority Data
Oct. 26, 2010 (KR) 10-2010-0104829

(51) Int. Cl. B23P 19/00

(52) U.S. Cl. 29/745

(57) ABSTRACT

An apparatus for manufacturing a transparent electrode using a print-based metal wire is provided which can mass produce the transparent electrode as a substitute for ITO at low cost. The apparatus for manufacturing a transparent electrode using a print-based metal wire includes: a print unit that forms a metal wire in a pattern set for a transparent film; and a coating unit that coats a solution type transparent electrode on the transparent film.

### CROSS-REFERENCE TO RELATED APPLICATION

This application claims priority to and the benefit of Korean Patent Application No. 10-2010-01 04829 filed in the Korean Intellectual Property Office on Oct. 26, 2010, the entire contents of which are incorporated herein by reference.

### BACKGROUND OF THE INVENTION

(a) Field of the Invention

The present invention relates to an apparatus for manufacturing a transparent electrode using a print-based metal wire, which enables the mass production of the transparent electrode at low cost.

(b) Description of the Related Art

In general, a transparent electrode is a functional thin film electrode that allows light in a visible light region to pass through and has given electrical conductivity. For example, transparent electrodes are used in flat panel displays such as liquid crystal displays (LCDs), plasma display panels (PDPs), organic light emitting displays (OLEDs), and field emission displays (FEDs), touch panels, transparent electromagnetic wave shielding films, transparent electrostatic protective films, planar antennas for communication devices, heat reflective coatings, and solar cells.

The transparent electrodes has two properties: high electrical conductivity with a specific resistance of less than 1×10⁻³Ω/sq and a surface resistance of less than 10³Ω/sq; and a transmittance of more than 80% in a visible light region of 380 to 780 nm. Accordingly, conductive material used for the transparent electrodes include metals, metal oxides, conductive polymers, carbon materials and the like.

Indium tin oxide (ITO), an example of metal oxide conductive material, is widely used because of high transmittance and low electrical resistance. However, indium which is a main material of ITO is very expensive and requires expensive vacuum deposition equipment in the manufacturing process of an ITO thin film the main raw material of ITO is indium, which is expensive.

Moreover, a transparent electrode formed by coating ITO on a plastic film is easily shattered even under a small external impact or stress, shows low mechanical stability when the plastic film is bent or folded, and undergoes changes in electrical characteristics due to thermal deformation caused by the difference in thermal expansion coefficient with the plastic film.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for manufacturing a transparent electrode using a print-based metal wire in order to mass-produce the transparent electrode as a substitute for ITO.

An exemplary embodiment of the present invention provides an apparatus for manufacturing a transparent electrode using a print-based metal wire, the apparatus including: a print unit that forms a metal wire in a pattern set for a transparent film; and a coating unit that coats a solution type transparent electrode on the transparent film.

The apparatus for manufacturing a transparent electrode using a print-based metal wire according to an exemplary embodiment of the present invention may further include a surface treatment unit that treats the surface of the transparent film being fed from a feed roll to a retrieving roll.

The apparatus for manufacturing a transparent electrode using a print-based metal wire according to an exemplary embodiment of the present invention may further include drying portions provided behind the print unit and the coating unit.

The print unit may include: an incised print unit that forms concave grooves in the transparent film and forms a metal wire in the concave grooves; and a raised print unit that forms a protruding metal wire on the surface of the transparent film, wherein the incised print unit and the raised print unit may be alternatively used.

The incised print unit may be formed by any one of the following: a thermal roll imprinting unit, a hot embossing unit, a nanoimprint lithography (NIL) unit, and a thermal imprinting unit.

The incised print unit may include: a heating roll mounted with an imprinting stamp with an original pattern to be imprinted on the transparent film; a sub roll disposed opposite the heating roll to support the transparent film; and a doctor blade that forms a metal wire by filling a metal paste in the imprinted transparent film.

The raised print unit may be formed by any one of the following: a gravure printing unit, an offset printing unit, an inkjet printing unit, a micro contact printing unit, a flexo printing unit, and a screen printing unit.

The raised print unit may include: a gravure roll for forming a metal paste pattern; a blanket roll for transferring the patterned metal paste of the gravure roll onto the transparent film in contact with the transparent film; and a sub roll disposed opposite the blanket roll to support the transparent film.

The coating unit may be formed by any one of the following: a spin coating unit, a slot die coating unit, an electrostatic deposition (ESD) coating unit, a spray coating unit, and a micro gravure coating unit.

According to an exemplary embodiment of the present invention, the print unit forms a metal wire in the pattern set for the transparent film, and the coating unit coats a solution type transparent electrode on the transparent film, thereby offering high electrical conductivity caused by the metal wire and high transmittance caused by the solution type transparent electrode and the transparent film, i.e., mass-producing transparent electrodes, which are cheap and can replace ITO.

Moreover, an exemplary embodiment of the present invention enables it to form a transparent electrode of an incised or raised type on a transparent film with the use of single equipment by alternatively driving the incised print unit and raised print unit of the print unit.

### BRIEF DESCRIPTION OF THE DRAWINGS

FIG. 1 is a view showing the configuration of an apparatus for manufacturing a transparent electrode using a print-based metal wire according to one exemplary embodiment of the present invention.

FIG. 2 is an operational state view showing the formation of a metal wire in concave grooves of a transparent film by using the transparent electrode manufacturing apparatus of FIG. 1.

FIG. 3 is an operational state view showing the formation of a metal wire on a transparent film by a thermal roll imprinting method.

FIG. 4 is an operational state view showing the formation of a metal wire on the surface of a transparent film by using the transparent electrode manufacturing apparatus of FIG. 1.

FIG. 5 is an operational state view showing the formation of a metal wire on a transparent film by a gravure offset printing method.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

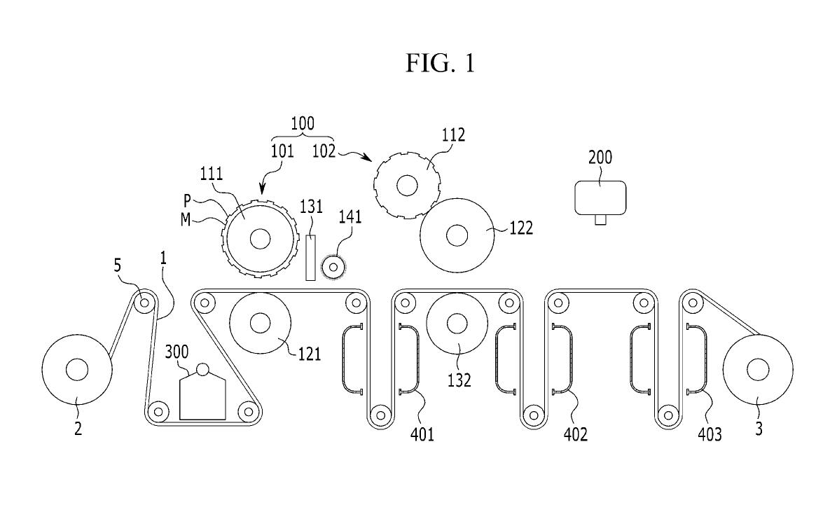

FIG. 1 is a view showing the configuration of an apparatus for manufacturing a transparent electrode using a print-based metal wire according to one exemplary embodiment of the present invention. Referring to FIG. 1, the transparent electrode manufacturing apparatus includes a print unit 100 and a coating unit 200, and is formed to manufacture a transparent electrode in a continuous process.

That is, the print unit 100 forms a metal wire in a pattern set for a transparent film 1, and the coating unit 200 coats a solution type transparent electrode on the transparent film 1 with the metal wire. For example, the transparent film 1 may be formed of a thermally deformable plastic film.

Moreover, the transparent electrode manufacturing apparatus has a feed roll 2 for continuously feeding the transparent film 1, a retrieving roll 3, and a surface treatment unit 300 for treating the surface of the transparent film 1.

Support rolls 5 are provided between the feed roll 2 and the retrieving roll 3 to support the transparent film 1 being continuously fed and set the feeding direction of the transparent film 1. The feed roll 2, the retrieving roll 3, the support roll 5, and the strip-shaped transparent film 1 enable the production of a transparent electrode by a print-based continuous process. That is, the transparent film can be mass-produced at low cost by a roll-to-roll print-based process.

The surface treatment unit 300 is installed in front of the print unit 100, and allows the transparent film 1 to pass through. The surface treatment unit 300 treats the surface of the transparent film 1 fed in one direction by the feed roll 2 and the retrieving roll 3, thus allowing the print unit 100 to form a metal wire on the transparent film 1 and the coating unit 200 to coat a solution type transparent electrode on the transparent film 1.

For example, the surface treatment unit 300 may be formed as a UV lamp (see FIG. 1) or plasma processing unit (not shown) to stabilize and clean the surface of the transparent film 1 with UV or plasma.

The print unit 100 is formed to correspond to the shape of the metal shape on the transparent film 1. For example, the print unit 100 includes an incised print unit 101 for forming concave grooves on the transparent film 1 and a metal wire in the concave grooves and a raised print unit 102 that forms a protruding metal wire on the surface of the transparent film 1.

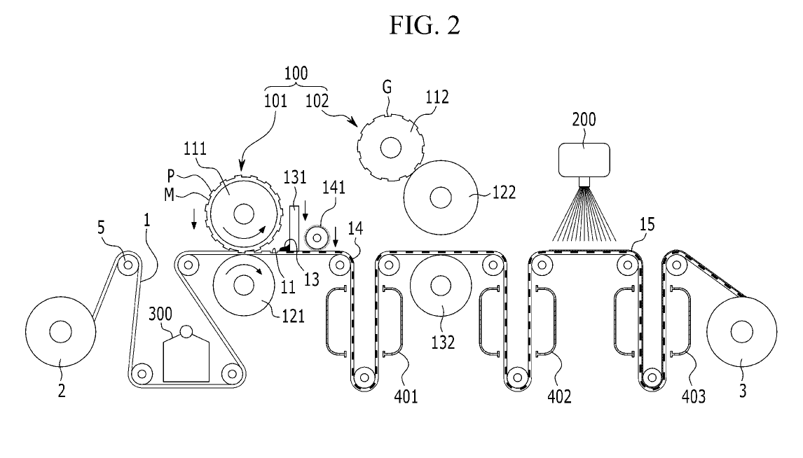

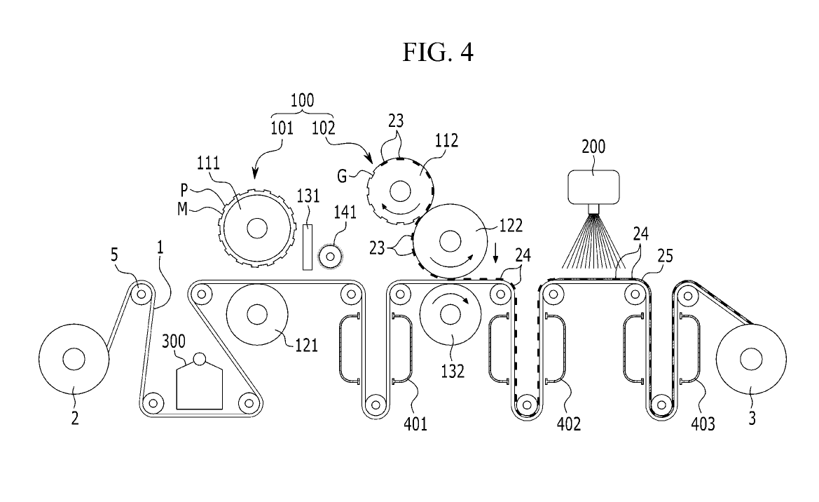

Of the print unit 100, the incised print unit 101 and the raised print unit 102 can be alternatively used according to a formation method of a transparent electrode. As shown in FIG. 2, as the incised print unit 101 is operated, a metal wire is formed by the incised print unit 101. Also, as shown in FIG. 4, as the raised print unit 102 is operated, a metal wire is formed by the raised print unit 102.

Moreover, the transparent electrode manufacturing apparatus may further include first, second, and third drying portions 401, 402, and 403 that are provided behind the print unit 100 and the coating unit 200. That is, the first and second drying portions 401 and 402 are provided behind the incised print unit 101 and the raised print unit 102, respectively. Thus, the first and second drying portions 401 and 402 dry the metal wire segments printed on the transparent film 1 to make faster the coating of a solution type transparent electrode, which is a subsequent process.

The third drying portion 403 dries the solution type transparent electrode coated on the transparent film 1 by the coating unit 200 after a printing process, so that the transparent film 1 with the transparent electrode can be wound around the retrieving roll 3.

The incised print unit 101 may be formed by any one of the following: a thermal roll imprinting unit, a hot embossing unit, a nanoimprint lilthography (NIL) unit, and a thermal imprinting unit, and the raised print unit 102 may be formed by any one of the following: a gravure printing unit, an offset printing unit, an inkjet printing unit, a micro contact printing unit, a flexo printing unit, and a screen printing unit. For convenience of explanation, the present exemplary embodiment will be described assuming that the incised print unit 102 is of the thermal roll imprinting type and the raised print unit 102 is of the gravure printing type.

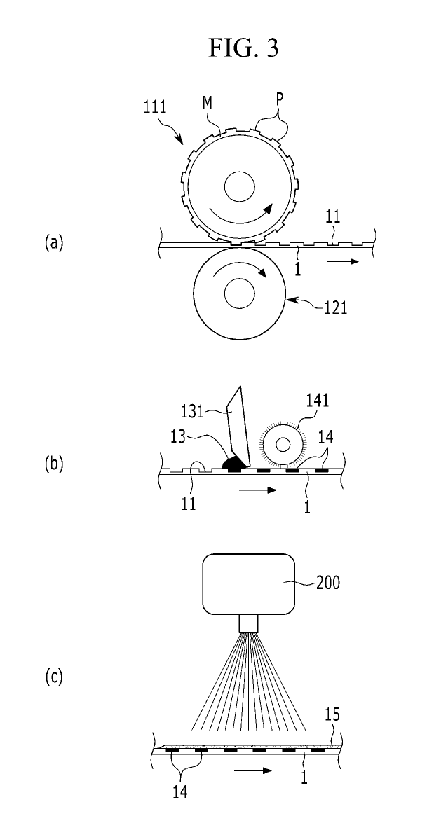

FIG. 2 is an operational state view showing the formation of a metal wire in concave grooves of a transparent film by using the transparent electrode manufacturing apparatus of FIG. 1, and FIG. 3 is an operational state view showing the formation of a metal wire 14 on a transparent film 1 by a thermal roll imprinting method.

Referring to FIG. 3 and FIG. 3, the incised print unit 101 includes a heating roll 111 for forming a metal wire 14 on a transparent film 1, a sub roll 121, a doctor blade 131, and a cleaning roll 141.

The heating roll 111 is mounted with an imprinting stamp S with an original pattern P to be imprinted on the transparent film 1. The sub roll 121 is disposed opposite the heating roll 111, and supports the transparent film 1 so that the heating roll 111 imprints the transparent film 1 (refer to (a) of FIG. 3). At this point, the transparent film 1 is surface-treated at the surface treatment unit 300 by driving the feed roll 2 and the retrieving roll 3, and then fed between the heating roll 111 and the sub roll 121.

After the imprinting, the doctor blade 131 forms the metal wire 14 by filling a metal paste 13 in the concave grooves 11 of the transparent film 1 being fed (b). The meal wire 14 may have a circular, triangular, hexagonal, crosshatched, crossed, or mesh-like shape having a predetermined line width interval, and combinations and modifications thereof.

At this point, the cleaning roll 141 cleans the surface of the transparent film 1 being fed and the surface of the metal wire 14 (refer to (b) of FIG. 3). Accordingly, the metal wire 14 filled in the concave grooves 11 forms a planar surface having the same height as the surface of the transparent film 1.

That is, a transparent electrode is planar on both sides of the transparent film 1. As the transparent film 1 passes through the first drying portion 401, the metal wire 14 is dried. At this point, the incised print unit 102 is not operated; the second drying portion 402 may be operated or not.

When the transparent film 1 with the metal wire 14 formed thereon is further fed, the coating unit 200 coats a solution type transparent electrode 15 on the transparent film 1 (refer to (c) of FIG. 3). Therefore, the solution type transparent electrode 15 has the same coating thickness as the metal wire 14 and the transparent film 1. As the transparent film 1 passes through the third drying portion 403, the solution type transparent electrode 15 is dried. The solution type transparent electrode 15 may be replaced with conductive polymer, CNT, or graphene.

For example, the coating unit 200 may be formed by any one of the following: a spin coating unit, a slot die coating unit, an electrostatic deposition (ESD) coating unit, a spray coating unit, and a micro gravure coating unit. In a driving operation, spin coating causes the transparent film 1 to be rotated, and therefore is applicable to the case where the transparent film 1 is cut to a predetermined length (not shown).

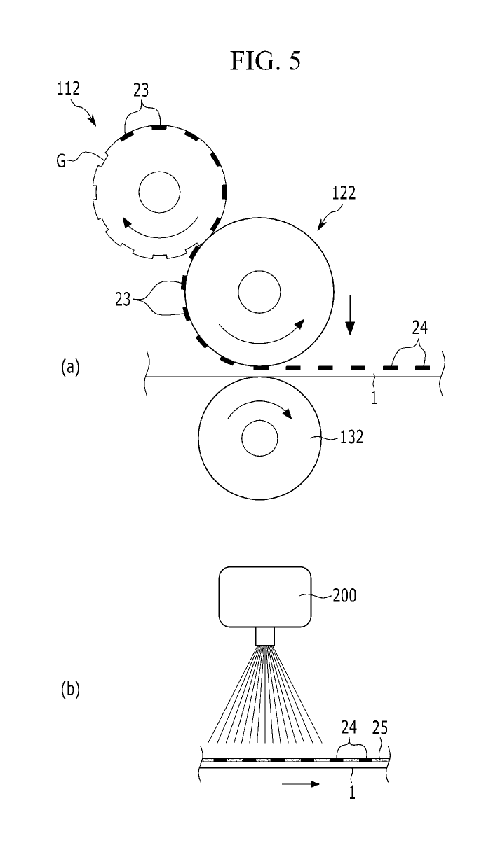

FIG. 4 is an operational state view showing the formation of a metal wire on the surface of a transparent film by using the transparent electrode manufacturing apparatus of FIG. 1, and FIG. 5 is an operational state view showing the formation of a metal wire 24 on a transparent film 21 by a gravure offset printing method.

Referring to FIG. 4 and FIG. 5, the raised print unit 102 includes a gravure roll 112 for forming a protruding thin metal wire 24 on the surface of the transparent film 21, a blanket roll 122, and a sub roll 132.

The gravure roll 112 has a concave groove (G) pattern so as to form a metal paste 23 pattern, and is driven by the metal paste 23 filled in the concave grooves G. The blanket roll 122 transfers the patterned metal paste 23 of the gravure roll 112 onto the surface of the transparent film 21 as it rotates in contact with the gravure roll 112 and the transparent film 21 (refer to (a) of FIG. 5). The sub roll 132 is disposed opposite the blanket roll 122, and supports the transparent film 21 along with the blanket roll 122. At this point, the transparent film 21 is surface-treated at the surface treatment unit 300 by driving the feed roll 2 and the retrieving roll 3, and then fed between the blanket roll 122 and the sub roll 132.

Accordingly, the metal wire 24 formed on the surface of the transparent film 21 is formed with a greater height than the surface of the transparent film 21. As the transparent film 21 passes through the second drying portion 402, the metal wire 24 is dried. Moreover, the incised print unit 101 and the first drying portion 401 are not operated.

When the transparent film 21 with the metal wire 24 formed thereon is further fed, the coating unit 200 coats a solution type transparent electrode 25 on the transparent film 21 (refer to (b) of FIG. 5). Therefore, the solution type transparent electrode 25 and the metal wire 24 form a planar surface because they have the same thickness on the transparent film 21. That is, the transparent electrode is planar on the both sides. As the transparent film 21 passes through the third drying portion 403, the solution type transparent electrode 25 is dried.

As such, the transparent electrode manufacturing apparatus of one exemplary embodiment can have the advantage of producing a transparent electrode of an incised or raised type with the use of single equipment by alternatively driving the incised print unit 101 and the raised print unit 102.

In one exemplary embodiment, a transparent electrode is formed based on a printing process. This makes it rather easy to produce a transparent electrode at room temperature without the need of a vacuum or deposition process. In other words, one exemplary embodiment requires no expensive transparent electrode material (e.g., ITO, ZnO, and TiO₂) and no expensive equipment (e.g., vacuum deposition equipment).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for manufacturing a transparent electrode using a print-based metal wire, the apparatus comprising:
a print unit that forms a metal wire in a pattern set for a transparent film; and
a coating unit that coats a solution type transparent electrode on the transparent film.

2. The apparatus of claim 1, further comprising a surface treatment unit that treats the surface of the transparent film being fed from a feed roll to a retrieving roll.

3. The apparatus of claim 1, further comprising drying portions provided behind the print unit and the coating unit.

4. The apparatus of claim 1, wherein the print unit comprises:
an incised print unit that forms concave grooves in the transparent film and forms a metal wire in the concave grooves; and
a raised print unit that forms a protruding metal wire on the surface of the transparent film,
wherein the incised print unit and the raised print unit are alternatively used.

5. The apparatus of claim 4, wherein the incised print unit is formed by any one of the following: a thermal roll imprinting unit, a hot embossing unit, a nanoimprint lithography unit, and a thermal imprinting unit.

6. The apparatus of claim 4, wherein the incised print unit comprises:
a heating roll mounted with an imprinting stamp with an original pattern to be imprinted on the transparent film;
a sub roll disposed opposite the heating roll to support the transparent film; and
a doctor blade that forms a metal wire by filling a metal paste in the imprinted transparent film.

7. The apparatus of claim 4, wherein the raised print unit is formed by any one of the following: a gravure printing unit, an offset printing unit, an inkjet printing unit, a micro contact printing unit, a flexo printing unit, and a screen printing unit.

8. The apparatus of claim 4, wherein the raised print unit comprises:
a gravure roll for forming a metal paste pattern;
a blanket roll for transferring the patterned metal paste of the gravure roll onto the transparent film in contact with the transparent film; and
a sub roll disposed opposite the blanket roll to support the transparent film.

9. The apparatus of claim 1, wherein the coating unit is formed by any one of the following: a spin coating unit, a slot die coating unit, an ESD coating unit, a spray coating unit, and a micro gravure coating unit.
